(19) United States
(12) Patent Application Publication
(10) Pub. No.: US 2022/0300707 A1
(43) Pub. Date: Sep. 22, 2022

(54) SYSTEMS AND METHODS FOR GENERATING TERM DEFINITIONS USING RECURRENT NEURAL NETWORKS

(71) Applicant: Capital One Services, LLC, McLean, VA (US)

(72) Inventors: Sarvani KARE, Clarksville, MD (US); Stephen FLETCHER, Arlington, VA (US)

(73) Assignee: Capital One Services, LLC, McLean, VA (US)

(21) Appl. No.: 17/205,722

(22) Filed: Mar. 18, 2021

(51) Int. Cl. G06F 40/279; G06N 3/04; G06N 3/08; G06F 40/169

(52) U.S. Cl. CPC G06F 40/279; G06N 3/0445; G06N 3/08; G06F 40/169; G06F 40/242

(57) ABSTRACT

A method of determining a definition for a term associated with a specific domain may include: receiving, via a processor, an electronic document that is associated with a specific domain, the electronic document including at least one term; determining a definition of the at least one term via a machine learning model that is trained, based on (i) a plurality of terms associated with the specific domain as training data and (ii) definitions associated with the specific domain and corresponding to the plurality of terms as ground truth, to generate an output definition associated with the specific domain in response to an input term; and transmitting a response to receiving the electronic document that includes the determined definition of the at least one term.

### TECHNICAL FIELD

Various embodiments of the present disclosure relate generally to machine-learning-based techniques for determining definitions of terms, and, more particularly, to systems and methods for generating term definitions using recurrent neural networks.

### BACKGROUND

Data management is a problem that generally increases with scale. For example, data field descriptions can be a fundamental activity for promoting a healthy understanding, use, and lineage of a dataset. However, the task of entering and/or assigning descriptions to data fields can scale dramatically. For example, while it may be feasible to manually enter and maintain field descriptions for a dataset with ten or even one hundred fields, some entities, such as large-scale organizations, may manage hundreds of thousands of data fields or more. Manually maintaining data field descriptions for such data sets may thus represent a significant burden in terms of cost, person-hours, and complexity. Further, because data field descriptions generally are based on information outside of the dataset itself, conventional techniques of automation are ill suited to addressing this problem.

The present disclosure is directed to addressing above-referenced challenges. The background description provided herein is for the purpose of generally presenting the context of the disclosure. Unless otherwise indicated herein, the materials described in this section are not prior art to the claims in this application and are not admitted to be prior art, or suggestions of the prior art, by inclusion in this section.

### SUMMARY OF THE DISCLOSURE

According to certain aspects of the disclosure, methods and systems are disclosed for determining a definition for a term associated with a specific domain. An entity may desire to automate the generation of a definition of a term, e.g., a description for a data field in a database. However, the task of determining a definition of a term is generally ill suited to conventional approaches for automation.

As will be discussed in more detail below, in various embodiments, systems and methods for using machine learning to automate the generation of term definitions, e.g., data field descriptions, are described. By training a machine learning model, e.g., via supervised or semi-supervised learning, to learn associations between terms in a specific domain and natural language definitions for those terms, the trained machine learning model may be configured to generate an output natural language definition for an input term within the specific domain.

In one aspect, an exemplary embodiment of a computer-implemented method of determining a definition for a term associated with a specific domain may include: receiving, via a processor, an electronic document that is associated with a specific domain, the electronic document including at least one term; determining a definition of the at least one term via a machine learning model that is trained, based on (i) a plurality of terms associated with the specific domain as training data and (ii) definitions associated with the specific domain and corresponding to the plurality of terms as ground truth, to generate an output definition associated with the specific domain in response to an input term; and transmitting a response to receiving the electronic document that includes the determined definition of the at least one term.

In another aspect, a method of training a machine learning model to output a definition associated with a specific domain in response to an input term may include: receiving a plurality of terms and definitions associated with a specific domain and corresponding to the plurality of terms; performing a pre-processing on each of the plurality of terms and on each of the corresponding definitions, wherein the pre-processing is predetermined based on the specific domain; and training a machine learning model, based on the pre-processed plurality of terms as training data and the corresponding pre-processed definitions as ground truth, to generate an output definition associated with the specific domain in response to an input term.

In a further aspect, an exemplary embodiment of a system for determining a definition association with a specific domain of a term in an electronic document may include: a processor; and a memory that is operatively connected to the processor, and that stores: a machine learning model that is trained, based on (i) a plurality of terms associated with a specific domain as training data and (ii) definitions associated with the specific domain and corresponding to the plurality of terms as ground truth, to: learn associations between (iii) at least a portion of one or more of the plurality of terms in the training data and (iv) at least a portion of the one or more corresponding definitions; and generate an output definition associated with the specific domain in response to an input term; and instructions that are executable by the processor to cause the processor to perform operations. The operations may include: receiving an electronic document that is associated with the specific domain, the electronic document including at least one term; performing a pre-processing on the at least one term, wherein the pre-processing is predetermined based on the specific domain; determining a definition of the at least one term via the machine learning model; and transmitting a response to receiving the electronic document that includes the determined definition of the at least one term.

It is to be understood that both the foregoing general description and the following detailed description are exemplary and explanatory only and are not restrictive of the disclosed embodiments, as claimed.

### BRIEF DESCRIPTION OF THE DRAWINGS

The accompanying drawings, which are incorporated in and constitute a part of this specification, illustrate various exemplary embodiments and together with the description, serve to explain the principles of the disclosed embodiments.

FIG. 1 depicts an exemplary computing environment for training and/or using a machine learning model for determining a definition for a term associated with a specific domain, according to one or more embodiments.

FIG. 2 depicts a flowchart of an exemplary method of training a machine learning model to determine a definition for a term associated with a specific domain, according to one or more embodiments.

FIG. 3 depicts a flowchart of an exemplary method of using a machine learning model to determine a definition for a term associated with a specific domain, according to one or more embodiments.

FIG. 4 depicts an example of a computing device, according to one or more embodiments.

### DETAILED DESCRIPTION OF EMBODIMENTS

The terminology used below may be interpreted in its broadest reasonable manner, even though it is being used in conjunction with a detailed description of certain specific examples of the present disclosure. Indeed, certain terms may even be emphasized below; however, any terminology intended to be interpreted in any restricted manner will be overtly and specifically defined as such in this Detailed Description section. Both the foregoing general description and the following detailed description are exemplary and explanatory only and are not restrictive of the features, as claimed.

In this disclosure, the term “based on” means “based at least in part on.” The singular forms “a,” “an,” and “the” include plural referents unless the context dictates otherwise. The term “exemplary” is used in the sense of “example” rather than “ideal.” The terms “comprises,” “comprising,” “includes,” “including,” or other variations thereof, are intended to cover a non-exclusive inclusion such that a process, method, or product that comprises a list of elements does not necessarily include only those elements, but may include other elements not expressly listed or inherent to such a process, method, article, or apparatus. Relative terms, such as, “substantially” and “generally,” are used to indicate a possible variation of ±10% of a stated or understood value.

As used herein, the term “data” generally encompasses any type of information that may be electronically stored, e.g., via a computer-readable medium. A “data field” generally encompasses a class, category, group, segment, or the like, of data. In other words, an entry of data into a data field may represent one possible value for a type of data represented by that data field. Data may be relational, e.g., via a relational database. For example, data associated with a person may include data categorized into fields such as “age,” “gender”, “height,” etc. The term “entity” generally encompasses an organization or person, e.g., that may be involved in managing and/or providing a good, service, information, interaction, or the like. Terms such as “user,” generally encompass a person using a device in order to view, obtain, and/or interact with an entity. A “specific domain” generally encompasses a category of subject matter generally associated with terminology and/or meaning of terms specific to the category. For example, a “port” has a different understood meaning in the category of computing compared to the category of shipping. A “definition” generally encompasses an explanation of the domain-specific meaning of a term using terms not specific to the specific domain, e.g., a natural language definition.

As used herein, a “machine learning model” generally encompasses instructions, data, and/or a model configured to receive input, and apply one or more of a weight, bias, classification, or analysis on the input to generate an output. The output may include, for example, a classification of the input, an analysis based on the input, a design, process, prediction, or recommendation associated with the input, or any other suitable type of output. A machine learning model is generally trained using training data, e.g., experiential data and/or samples of input data, which are fed into the model in order to establish, tune, or modify one or more aspects of the model, e.g., the weights, biases, criteria for forming classifications or clusters, or the like. Aspects of a machine learning model may operate on an input linearly, in parallel, via a network (e.g., a neural network), or via any suitable configuration.

The execution of the machine learning model may include deployment of one or more machine learning techniques, such as linear regression, logistical regression, random forest, gradient boosted machine (GBM), deep learning, and/or a deep neural network. Supervised and/or unsupervised training may be employed. For example, supervised learning may include providing training data and labels corresponding to the training data. Unsupervised approaches may include clustering, classification or the like. K-means clustering or K-Nearest Neighbors may also be used, which may be supervised or unsupervised. Combinations of K-Nearest Neighbors and an unsupervised cluster technique may also be used. Any suitable type of training may be used, e.g., stochastic, gradient boosted, random seeded, recursive, epoch or batch-based, etc.

An entity may desire to generate and/or maintain definitions for terms within a specific domain. For example, the entity may desire to maintain a dictionary of terms to enable users, e.g., software developers or the like, to use and understand data entries used in a document, stored in a database, and/or utilized by an electronic application. In another example, an electronic application developed, managed, provided, and/or supported by the entity may require data and/or data fields to be registered in order to be utilized by the electronic application, which may include and/or require the use of data field descriptions. In a further example, the entity may desire to understand how data is used or is related between various items or sources. For instance, an item such as a data file and/or an electronic document, e.g., an automatically generated system log, or the like, may include various data entries and/or data fields. For example, an electronic document may include a data entry of “443” for a data field of “ms:dsPort-ssl.” The entity may desire to understand what the data field pertains to, what data is used, how the data may relate to other data and/or resources, etc.

In some instances, the entity may obtain and/or maintain an index of terms and associated definitions, whereby a definition may be applied to a term in an electronic document via a lookup in the index. However, such a lookup would only be possible in instances where the definition of a term is already included in the index. A person familiar with a specific domain may be able to understand at least a portion of what is signified by the data field, e.g., a port associated with communications over a Secure Socket Layer (“SSL”), and thus may understand that the data entry of “443” is an identification of the number of that port and therefore be able to generate and/or apply such a definition to the term. In an example, the person may generate a definition of the data field above as, “Specifies which port to be used by the directory service for SSL requests.”

However, the person, system, or entity desiring to use and/or understand the data may not have an understanding comparable to that of the person familiar with the specific domain. Further, while it may be feasible for the person or persons familiar with the specific domain to generate, maintain and understand a small number of data field definitions/descriptions, many activities may include a quantity of data fields that make manual generation and/or maintenance of data field descriptions overly time consuming, complex, or infeasible. For example, some organization activities may include hundreds of thousands of data fields, and it may thus be impractical to assign the task of generating a description of each field to human generation. Accordingly, improvements in technology relating to automated generation of definition of terms within a specific domain, e.g., data field descriptions, are needed.

In the following description, embodiments will be described with reference to the accompanying drawings. As will be discussed in more detail below, in various embodiments, systems and methods for determining a definition for a term associated with a specific domain are described.

In an exemplary use case, an entity system may automatically generate an electronic document, e.g., a system event log, or the like. The electronic document may include one or more terms, e.g., data fields that pertain to a specific domain, along with data entries corresponding to those fields. An entity associated with the entity system may desire to maintain an understanding of the data used and/or impacted by the electronic document. For example, the entity may desire to annotate the electronic document with definitions of terms in the electronic document and/or descriptions of data fields in the electronic document. The entity system may provide, e.g., transmit, the electronic document to a definition engine system. The definition engine system may determine a definition of at least one term in the electronic document via a trained machine learning model. The trained machine learning model may be trained, based on (i) a plurality of terms associated with the specific domain as test data and (ii) definitions associated with the specific domain and corresponding to the plurality of terms as ground truth, to generate an output definition associated with the specific domain in response to an input term. The definition engine system may provide, e.g., transmit, a response, e.g., to the entity system, that includes the determined definition of the at least one term.

In another exemplary use case, an entity may desire to train a machine learning model to output a definition associated with a specific domain in response to an input term, e.g., in a manner similar to the example above. The entity may train the machine learning model using supervised learning. A definition engine system may receive (i) a plurality of terms and (ii) definitions associated with a specific domain and corresponding to the plurality of terms. The definition engine system may perform a pre-processing on each of the plurality of terms and on each of the corresponding definitions. The pre-processing may be specific to, e.g., predetermined based on, the specific domain. The definition engine system may train the machine learning model, based on the pre-processed plurality of terms as training data and the corresponding pre-processed definitions as ground truth, to generate an output definition associated with the specific domain in response to an input term.

In an example of a result that may be achieved by one or more of the techniques above, an electronic document that has been processed by a definition engine system may include an annotation providing a description and/or definition of a term or data field. For example, an electronic document provided to the definition engine system may include the data field “ms:dsPort-ssl,” along with the data entry “443.” The result of the processing by the definition engine system may include adding an annotation to the electronic document for that data field that describes the data field as “Specifies which port to be used by the directory service for SSL requests.” Thus, a person reviewing the annotated document would understand that the “port to be used by the directory service for SSL requests” is port “443.”

While several of the examples above involve generating descriptions for data fields, it should be understood that techniques according to this disclosure may be adapted to generation of any suitable type of definition or description, e.g., a dictionary, glossary, etc. It should also be understood that the examples above are illustrative only. The techniques and technologies of this disclosure may be adapted to any suitable activity.

Presented below are various aspects of machine learning techniques that may be adapted to automatic generation of definitions of terms in a specific domain.

Conventional machine learning techniques are ill suited to generating definitions of terms. As an illustrative example, in the field of natural language processing, machine learning models may be trained to determine the context of a word in a sentence based on surrounding words and grammar, and then associate that determined context with a similar context in a different language. However, unlike language translation, in which syntax of the input and output languages provide structure that may be leveraged for developing context, there may not be any surrounding context for an individual term. In other words, while context may be usable to disambiguate a word with many meaning, e.g., “run a race” vs. “run an experiment”, this type of disambiguation may not be possible when the term is provided in isolation of any surrounding context.

As will be discussed in more detail below, machine learning techniques adapted to automatic generation of definitions of terms may include one or more aspects according to this disclosure, e.g., a particular selection of training data, a particular selection of pre-processing of the training data and/or input data, a particular training process for the machine learning model, limitation of the generated definitions to a specific domain, etc.

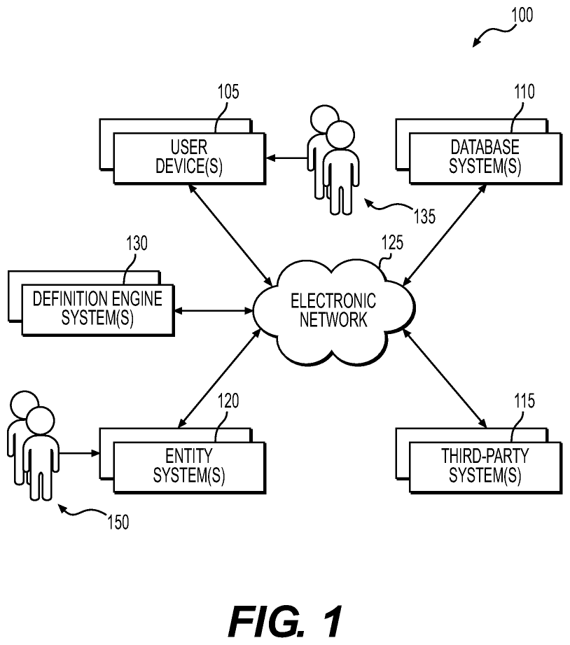

FIG. 1 depicts an exemplary computing environment 100 that may be utilized with techniques presented herein. One or more user device(s) 105, one or more database system(s) 110, one or more third-party system(s) 115, and one or more entity system(s) 120 may communicate across an electronic network 125. As will be discussed in further detail below, one or more definition engine system(s) 130 may communicate with one or more of the other components of the computing environment 100 across electronic network 125.

The one or more user device(s) 105 may be associated with a user 135, e.g., a user that desires to access and/or use data managed by the database system 110 and/or entity system 120. The entity system 120 may be associated with an entity 150. The systems and devices of the computing environment 100 may communicate in any arrangement. As will be discussed herein, systems and/or devices of the computing environment 100 may communicate in order to one or more of train or use a machine learning model to determine a definition and/or description of a term in a specific domain, among other activities.

The user device 105 may be configured to enable the user 135 to access and/or interact with other systems in the computing environment 100. For example, the user device 105 may be a computer system such as, for example, a desktop computer, a mobile device, etc. In some embodiments, the user device 105 may include one or more electronic application(s), e.g., a program, plugin, browser extension, etc., installed on a memory of the user device 105. In some embodiments, the electronic application(s) may be associated with one or more of the other components in the computing environment 100. For example, the electronic application(s) may include one or more of system control software, system monitoring software, software development tools, etc.

The database system 110 may store data, e.g., entries associated with data fields, definitions and/or descriptions corresponding to the data fields, etc. In some embodiments, the data includes training data for training a machine learning model, as discussed in further detail below. In some embodiments, the training data includes supervised training data, e.g., terms in a specific domain and definitions/descriptions associated with those terms. In some embodiments, the definitions/descriptions may be manually selected and/or applied to the terms. In some embodiments, pairs of definitions/descriptions and associated terms may be obtained from another source, e.g., the third-party system 115.

As used herein, a “term” generally encompasses an independent item or conceptual unit. Generally, a term is a single word, e.g., a single word term. In some instances, a single word term may include an abbreviation and/or portmanteau of one or more words. Several examples included herein use the word “term” interchangeable with a data field. However, it should be understood that techniques described herein may be applied to terms that are not used as data fields.

In some embodiments, each pair of term and corresponding definition in the training data and ground truth, respectively, is independent of each other. In other words, in contrast to training data generally used for natural language translation, the meaning of each term is not dependent on the meaning of any other term.

The third-party system 115, may include a system interacting with the entity system 120 and/or the database system 110, etc. For example, the third-party system 115 may be associated with an electronic application that provides data to and/or receives data from another system in the computing environment 100. The entity system 120 may include, for example, a server system, or the like. In some embodiments, the entity system 120 may host one or more electronic applications, e.g., an application associated with the operations of the entity 150 and/or a service provided by the entity 150.

In various embodiments, the electronic network 125 may be a wide area network (“WAN”), a local area network (“LAN”), personal area network (“PAN”), or the like. In some embodiments, electronic network 125 includes the Internet, and information and data provided between various systems occurs online. “Online” may mean connecting to or accessing source data or information from a location remote from other devices or networks coupled to the Internet. Alternatively, “online” may refer to connecting or accessing an electronic network (wired or wireless) via a mobile communications network or device. The Internet is a worldwide system of computer networks—a network of networks in which a party at one computer or other device connected to the network can obtain information from any other computer and communicate with parties of other computers or devices. The most widely used part of the Internet is the World Wide Web (often-abbreviated “WWW” or called “the Web”). A “website page” generally encompasses a location, data store, or the like that is, for example, hosted and/or operated by a computer system, e.g., the third-party system 115, so as to be accessible online, and that may include data configured to cause a program such as a web browser to perform operations such as send, receive, or process data, generate a visual display and/or an interactive interface, or the like.

As discussed in further detail below, the definition engine system 130 may one or more of generate, store, train or use a machine learning model to determine a definition and/or description of a term in a specific domain, among other activities. The definition engine system 130 may include a machine learning model and/or instructions associated with the machine learning model, e.g., instructions for generating a machine learning model, training the machine learning model, pre-processing training data, and/or pre or post processing input and output to the machine learning model. The definition engine system 130 may communicate with other systems in the computing environment 100, e.g., to obtain training data and/or input to feed into the machine learning model and/or to provide the output from the machine learning model.

In some embodiments, the machine learning model of the definition engine system 130 includes a Recurrent Neural Network (“RNN”). Generally, RNNs are a class of feed-forward neural networks that may be well adapted to processing a sequence of inputs with various lengths. In some embodiments, the machine learning model includes a Gated Recurrent Unit (“GRU”) based Encoder-Decoder RNN that utilizes an attention model. In some embodiments, the machine learning model includes a Sequence to Sequence (“Seq2Seq”) model.

For example, one architecture that may be used to build a Seq2Seq model is the Encoder Decoder architecture. An encoder may include one or more RNN units or its variants such as a GRU. The encoder may utilize one or more hidden states to convert an input into a vector, e.g., a sequence of numbers representative of the meaning of the input. An output sequence of the model may be initialized, e.g., with a start token, and then a decoder may include one or more further RNN units, or its variants, and may be configured to iteratively process the encoded vector of the input and the current output sequence to make a prediction for continuing the output sequence. In other words, the decoder, based on a vector output by the encoder in response to the input, may generate an output sequence by iteratively predicting next portions of the sequence based on the vector and the output sequence thus far. In some embodiments, one or more of the encoder or decoder each includes only a single stack of RNN units or its variants. Once an output sequence has been generated, language models may be used to determine a measurement of a likelihood of a sentence (as high-probability sentences may be associated with being syntactically and/or contextually correct).

Generally, an RNN or its variants includes one or more hidden states, e.g., neurons, that are used to determine a final state, e.g., the output vector. In a conventional natural language processing model, generally, only that last state, e.g., the output vector, is passed to a decoder. In some embodiments, when implementing GRUs, an attention model may be used to generate a unique mapping between the decoder output at each time step to all encoder hidden states. Thus, the decoder may have access to the entire input sequence and can selectively pick out specific elements from that sequence to produce the output. Training the model to learn to pay selective attention to these inputs and relate them to items in the output sequence may result in higher quality predictions. In other words, each item in the output sequence may be conditional on selective items in the input sequence. In some embodiments, the machine learning model generated, trained, and/or used by the definition engine system 130 may include an attention-based sequence-to-sequence model.

As discussed in further detail below, the machine learning model may be trained such that the trained machine learning model learns associations between (i) at least a portion of one or more of the plurality of terms in the training data and (ii) at least a portion of the one or more corresponding definitions. Via one or more of the techniques discussed above, a machine learning model may, in response to the input of a term, encode the term as a sequence of numbers, e.g., a vector, and decode the vector to generate an output sequence of words corresponding to the input, e.g., a definition/description, as discussed in further detail in the methods below.

Although depicted as separate components in FIG. 1, it should be understood that a component or portion of a component may, in some embodiments, be integrated with or incorporated into one or more other components. For example, a portion of the user device 105 may be integrated into the entity system 120. In another example, the definition engine system 130 may be integrated with the entity system 120 and/or the database system 110. Any suitable arrangement and/or integration of the various systems and devices of the computing environment 100 may be used.

In the methods below, various acts are described as performed or executed by a component from FIG. 1, such as the definition engine system 130, the user device 105, the entity system 120, or components thereof. However, it should be understood that in various embodiments, various components of the computing environment 100 discussed above may execute instructions or perform acts including the acts discussed below. Further, it should be understood that in various embodiments, various steps may be added, omitted, and/or rearranged in any suitable manner.

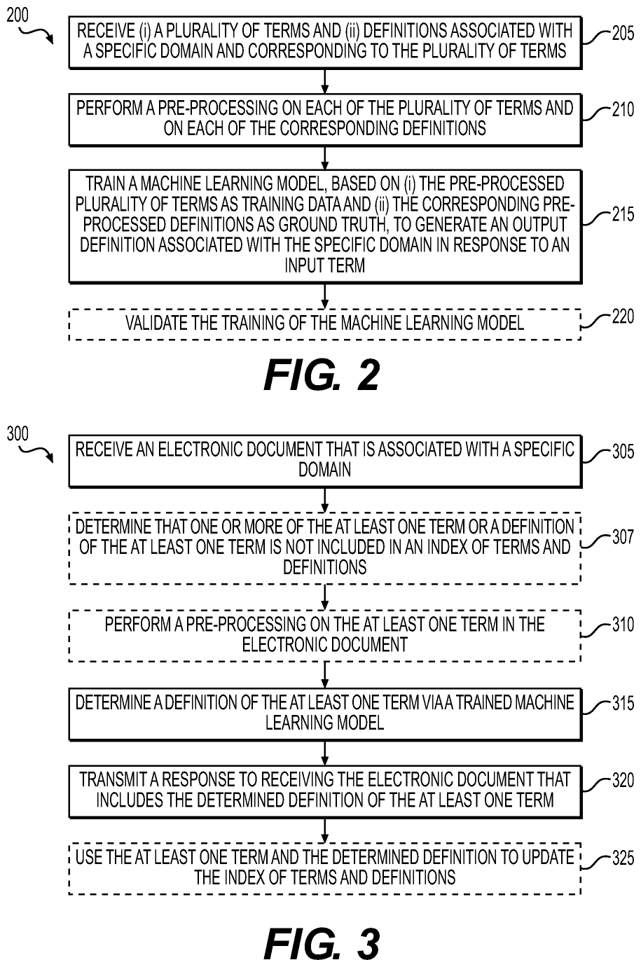

FIG. 2 illustrates an exemplary process for training a machine learning model to output a definition associated with a specific domain in response to an input term, such as in the various examples discussed above. At step 205, the definition engine system 130 may receive (i) a plurality of terms and (ii) definitions associated with a specific domain and corresponding to the plurality of terms. In some embodiments, each pair of term and associated definition is independent of each other. In some embodiments, each term is a single-word term.

At step 210, the definition engine system 130 may perform a pre-processing on each of the plurality of terms and on each of the corresponding definitions. In some embodiments, the pre-processing that is performed may be predetermined based on the specific domain, e.g., the pre-processing may be different for different specific domains.

In an example, the specific domain may be associated with software, network communications, or the like. Pre-processing may include one or more of, for each pair of term and definition: converting Unicode characters to ASCI characters; converting camel case characters to lower case characters (e.g., with spaces between); adding a start token and an end token at a beginning and end, respectively, of the term and/or the definition; removing one or more special characters, e.g., anything other than a-z, A-Z, “.”, “?”, “!”, or “,”, and inserting a space as a replacement; generating and/or updating an index mapping each term to an ID token and a reverse index mapping each ID token to a term, pad the term and definition, e.g., by appending spaces, to a predetermined maximum length; encoding the term and the definition in UTF-8 or any other suitable electronic character encoding schema; or generating an output in the format of [term, definition]. For example, pre-processing the field name and description pair of “ms:dsPort-ssl” and “Specifies which port to be used by the directory service for SSL requests” may result in an output of “[<start>ms ds port ssl<end>, <start> specifies which port to be used by the directory service for ssl requests <end>]”.

At step 215, the definition engine system 130 may train a machine learning model, based on (i) the pre-processed plurality of terms as training data and (ii) the corresponding pre-processed definitions as ground truth, to generate an output definition associated with the specific domain in response to an input term. In some embodiments, training the machine learning model includes training a pre-generated model. In some embodiments, training the machine learning model includes generating the machine learning model prior to applying the training data.

In an exemplary use case, an Application Programming Interface (“API”) may be used for the training, e.g., via a user 135 interacting with the definition engine system 130 via the user device 105. A GRU-based encoder may be used to encode an input term, e.g., generate a vector of one or more hidden states and an output fixed length vector. An attention model may be applied to this output to determine attention weights for the one or more hidden states, which may be used to determine a thought vector. Teacher training and/or teacher forcing may be used, e.g., by combining the output sequence generated by a decoder thus far (initialized with a start token) with the thought vector and one or more previous hidden states of the decoder to generate a next prediction for the output sequence.

In some embodiments, the training is configured to cause the machine learning model to learn associations between (i) at least a portion of one or more of the plurality of terms in the training data and (ii) at least a portion of the one or more corresponding definitions. In some embodiments, the trained machine learning model is configured to determine the definition of the input term independently of other data associated with the input term. For example, the input term may be associated with other data, e.g., an electronic document that includes the term along with other data, e.g., one or more other terms. The trained machine learning model may be configured to determine the definition of the input term without regard to, for example, the one or more other terms in the electronic document.

In an experimental training of a machine learning model according to the method discussed above, a training set of 5,850 field names and corresponding definitions was obtained. The training set included a vocabulary of 2,354 words. A test set of 1,463 field names and corresponding definitions was also obtained, and included a vocabulary of 4,751 words. An encoder and decoder were each implemented as a single stack of 1,024 forward GRU units. The length of the fixed length vector output was set to 256 values. Training was performed with a batch size of 64 over 50 epochs on a single P100 GPU. A loss function, e.g., categorical cross entropy, was used to calculate loss between the test set and output of the training set. Gradients based on the calculated loss were then calculated and back-propagated. Total training time was approximately 180 minutes. Results indicated that generated field descriptions in a significant number of instances were syntactically and semantically meaningful. Below, Table 1 depicts a few examples of the field descriptions generated by the trained model.

TABLE 1
Sample generated descriptions by the model

| Field Name | Generated Description |
|---|---|
| priority | the priority of the service request |
| os version | version of the operating system |
| bytes in | the number of bytes transferred |
| bytes out | the number of bytes transferred |
| client_ip | the client computer |

Optionally, at step 220, the training of the machine learning model may be validated, e.g., by comparing output descriptions of field names against predetermined descriptions for the field names. The validation may be performed via an algorithm and/or manually.

FIG. 3 illustrates an exemplary process for determining a definition for a term associated with a specific domain, such as in the various examples discussed above. At step 305, the definition engine system 130 may receive data, e.g., an electronic document, that is associated with a specific domain. The electronic document may include at least one term, e.g., a term with a meaning that is specific to the specific domain. The electronic document may be received from, for example, the entity system 120, the user device 105, the third-party system 115, or the like. The electronic document may be and/or include, for example, event record data, system log data, transmission data, or the like.

Optionally, at step 307, the definition engine system 130 may determine that one or more of the at least one term or a definition of the at least one term is not included in an index of terms and definitions that is, for example, stored and/or maintained by the database system 110.

Optionally, at step 310, the definition engine system 130 may perform a pre-processing on the at least one term in the electronic document, e.g., in a manner similar to the pre-processing discussed above. The pre-processing performed on the at least one term may be predetermined based on the specific domain. The pre-processing may be performed, for example, prior to at least step 315 below.

At step 315, the definition engine system 130 may determine a definition of the at least one term via a trained machine learning model, e.g., a model that is trained in a manner similar to the method of FIG. 2 discussed above. For instance, the machine learning model may be trained, based on (i) a plurality of terms associated with the specific domain as training data and (ii) definitions associated with the specific domain and corresponding to the plurality of terms as ground truth, to generate an output definition associated with the specific domain in response to an input term. The training of the machine learning model may be configured to cause the machine learning model to learn associations between (iii) at least a portion of one or more of the plurality of terms in the training data and (iv) at least a portion of the one or more corresponding definitions. In some embodiments, the machine learning model is further trained to determine the definition of the at least one term from the electronic document independently of a remainder of the electronic document.

At step 320, the definition engine system 130 may transmit, e.g., to the source of the electronic document, a response to receiving the electronic document that includes the determined definition of the at least one term. In some embodiments, transmitting the response includes adding an annotation to the electronic document that includes the determined definition. In some embodiments, transmitting the response includes performing a post-processing on the determined definition, e.g., to add punctuation, upper case letters, one or more modifications based on a natural language processing algorithm, or the like.

Optionally, at step 325, the definition engine system 130 may use the at least one term and the determined definition to update the index of terms and definitions, e.g., that is stored in the database system 110.

It should be understood that embodiments in this disclosure are exemplary only, and that other embodiments may include various combinations of features from other embodiments, as well as additional or fewer features. For example, while some of the embodiments above pertain to electronic documents, any suitable item may be used, e.g., a data file, a database or database entry, etc.

In general, any process or operation discussed in this disclosure that is understood to be computer-implementable, such as the processes illustrated in FIGS. 2 and 3, may be performed by one or more processors of a computer system, such any of the systems or devices in the computing environment 100 of FIG. 1, as described above. A process or process step performed by one or more processors may also be referred to as an operation. The one or more processors may be configured to perform such processes by having access to instructions (e.g., software or computer-readable code) that, when executed by the one or more processors, cause the one or more processors to perform the processes. The instructions may be stored in a memory of the computer system. A processor may be a central processing unit (CPU), a graphics processing unit (GPU), or any suitable types of processing unit.

A computer system, such as a system or device implementing a process or operation in the examples above, may include one or more computing devices, such as one or more of the systems or devices in FIG. 1. One or more processors of a computer system may be included in a single computing device or distributed among a plurality of computing devices. A memory of the computer system may include the respective memory of each computing device of the plurality of computing devices.

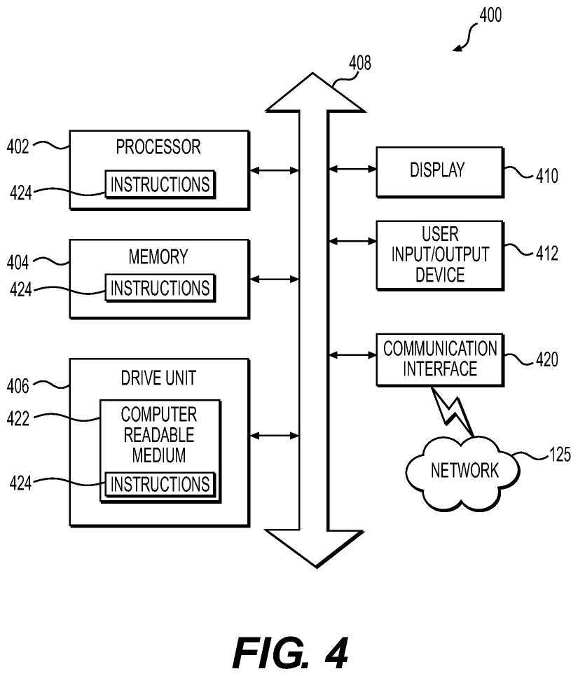

FIG. 4 is a simplified functional block diagram of a computer 400 that may be configured as a device for executing the methods of FIGS. 2 and 3, according to exemplary embodiments of the present disclosure. For example, the computer 400 may be configured as the definition engine system 130 and/or another system according to exemplary embodiments of the present disclosure. In various embodiments, any of the systems herein may be a computer 400 including, for example, a data communication interface 420 for packet data communication. The computer 400 also may include a central processing unit (“CPU”) 402, in the form of one or more processors, for executing program instructions. The computer 400 may include an internal communication bus 408, and a storage unit 406 (such as ROM, HDD, SDD, etc.) that may store data on a computer readable medium 422, although the computer 400 may receive programming and data via network communications. The computer 400 may also have a memory 404 (such as RAM) storing instructions 424 for executing techniques presented herein, although the instructions 424 may be stored temporarily or permanently within other modules of computer 400 (e.g., processor 402 and/or computer readable medium 422). The computer 400 also may include input and output ports 412 and/or a display 410 to connect with input and output devices such as keyboards, mice, touchscreens, monitors, displays, etc. The various system functions may be implemented in a distributed fashion on a number of similar platforms, to distribute the processing load. Alternatively, the systems may be implemented by appropriate programming of one computer hardware platform.

Program aspects of the technology may be thought of as “products” or “articles of manufacture” typically in the form of executable code and/or associated data that is carried on or embodied in a type of machine-readable medium. “Storage” type media include any or all of the tangible memory of the computers, processors or the like, or associated modules thereof, such as various semiconductor memories, tape drives, disk drives and the like, which may provide non-transitory storage at any time for the software programming. All or portions of the software may at times be communicated through the Internet or various other telecommunication networks. Such communications, for example, may enable loading of the software from one computer or processor into another, for example, from a management server or host computer of the mobile communication network into the computer platform of a server and/or from a server to the mobile device. Thus, another type of media that may bear the software elements includes optical, electrical and electromagnetic waves, such as used across physical interfaces between local devices, through wired and optical landline networks and over various air-links. The physical elements that carry such waves, such as wired or wireless links, optical links, or the like, also may be considered as media bearing the software. As used herein, unless restricted to non-transitory, tangible “storage” media, terms such as computer or machine “readable medium” refer to any medium that participates in providing instructions to a processor for execution.

While the presently disclosed methods, devices, and systems are described with exemplary reference to transmitting data, it should be appreciated that the presently disclosed embodiments may be applicable to any environment, such as a desktop or laptop computer, an automobile entertainment system, a home entertainment system, etc. Also, the presently disclosed embodiments may be applicable to any type of Internet protocol.

It should be appreciated that in the above description of exemplary embodiments of the invention, various features of the invention are sometimes grouped together in a single embodiment, figure, or description thereof for the purpose of streamlining the disclosure and aiding in the understanding of one or more of the various inventive aspects. This method of disclosure, however, is not to be interpreted as reflecting an intention that the claimed invention requires more features than are expressly recited in each claim. Rather, as the following claims reflect, inventive aspects lie in less than all features of a single foregoing disclosed embodiment. Thus, the claims following the Detailed Description are hereby expressly incorporated into this Detailed Description, with each claim standing on its own as a separate embodiment of this invention.

Furthermore, while some embodiments described herein include some but not other features included in other embodiments, combinations of features of different embodiments are meant to be within the scope of the invention, and form different embodiments, as would be understood by those skilled in the art. For example, in the following claims, any of the claimed embodiments can be used in any combination.

Thus, while certain embodiments have been described, those skilled in the art will recognize that other and further modifications may be made thereto without departing from the spirit of the invention, and it is intended to claim all such changes and modifications as falling within the scope of the invention. For example, functionality may be added or deleted from the block diagrams and operations may be interchanged among functional blocks. Steps may be added or deleted to methods described within the scope of the present invention.

The above disclosed subject matter is to be considered illustrative, and not restrictive, and the appended claims are intended to cover all such modifications, enhancements, and other implementations, which fall within the true spirit and scope of the present disclosure. Thus, to the maximum extent allowed by law, the scope of the present disclosure is to be determined by the broadest permissible interpretation of the following claims and their equivalents, and shall not be restricted or limited by the foregoing detailed description. While various implementations of the disclosure have been described, it will be apparent to those of ordinary skill in the art that many more implementations are possible within the scope of the disclosure. Accordingly, the disclosure is not to be restricted except in light of the attached claims and their equivalents.

What is claimed is:

1. A method of determining a definition for a term associated with a specific domain, the method comprising:
receiving, via a processor, an electronic document that is associated with a specific domain, the electronic document including at least one term;
determining a definition of the at least one term via a machine learning model that is trained, based on (i) a plurality of terms associated with the specific domain as training data and (ii) definitions associated with the specific domain and corresponding to the plurality of terms as ground truth, to generate an output definition associated with the specific domain in response to an input term; and
transmitting a response to receiving the electronic document that includes the determined definition of the at least one term.

2. The method of claim 1, wherein transmitting the response includes adding an annotation to the electronic document that includes the determined definition.

3. The method of claim 1, further comprising:
prior to determining the definition of the at least one term, performing a pre-processing on the at least one term, wherein the pre-processing is predetermined based on the specific domain.

4. The method of claim 1, wherein the at least one term is a single-word term.

5. The method of claim 1, wherein the training of the machine learning model is configured to cause the machine learning model to learn associations between (iii) at least a portion of one or more of the plurality of terms in the training data and (iv) at least a portion of the one or more corresponding definitions.

6. The method of claim 1, wherein the machine learning model includes only a single stack of encoders. The method of claim 1, wherein the machine learning model is an attention-based sequence-to-sequence model.

8. The method of claim 7, wherein the machine learning model includes a gated recurrent unit based encoder-decoder recurrent neural network.

9. The method of claim 1, wherein each pair of term and corresponding definition in the training data and ground truth, respectively, is independent of each other.

10. The method of claim 1, wherein the machine learning model is further trained to determine the definition of the at least one term from the electronic document independently of a remainder of the electronic document.

11. The method of claim 1, wherein the electronic document includes one or more of event or system log data.

12. A method of training a machine learning model to output a definition associated with a specific domain in response to an input term, the method comprising:
receiving a plurality of terms and definitions associated with a specific domain and corresponding to the plurality of terms;
performing a pre-processing on each of the plurality of terms and on each of the corresponding definitions, wherein the pre-processing is predetermined based on the specific domain; and
training a machine learning model, based on the pre-processed plurality of terms as training data and the corresponding pre-processed definitions as ground truth, to generate an output definition associated with the specific domain in response to an input term.

13. The method of claim 12, wherein the machine learning model is configured to perform the pre-processing on the input term prior to generating the output definition.

14. The method of claim 12, wherein each of the plurality of terms is a single-word term.

15. The method of claim 12, wherein the training of the machine learning model is configured to cause the machine learning model to learn associations between (iii) at least a portion of one or more of the plurality of terms in the training data and (iv) at least a portion of the one or more corresponding definitions.

16. The method of claim 12, wherein the machine learning model includes only a single stack of encoders.

17. The method of claim 12, wherein the machine learning model is an attention-based sequence-to-sequence model.

18. The method of claim 17, wherein the machine learning model includes a gated recurrent unit based encoder-decoder recurrent neural network.

19. The method of claim 12, wherein:
each pair of term and corresponding definition in the training data and ground truth, respectively, is independent of each other; and
the machine learning model is further trained to determine the definition of the input term independently of other data associated with the input term.

20. A system for determining a definition association with a specific domain of a term in an electronic document, the system comprising:
a processor; and
a memory that is operatively connected to the processor, and that stores:
a machine learning model that is trained, based on (i) a plurality of terms associated with a specific domain as training data and (ii) definitions associated with the specific domain and corresponding to the plurality of terms as ground truth, to:
learn associations between (iii) at least a portion of one or more of the plurality of terms in the training data and (iv) at least a portion of the one or more corresponding definitions; and
generate an output definition associated with the specific domain in response to an input term; and
instructions that are executable by the processor to cause the processor to perform operations, including:
receiving an electronic document that is associated with the specific domain, the electronic document including at least one term;
performing a pre-processing on the at least one term, wherein the pre-processing is predetermined based on the specific domain;
determining a definition of the at least one term via the machine learning model; and
transmitting a response to receiving the electronic document that includes the determined definition of the at least one term.
